(19) United States
(12) Patent Application Publication
(10) Pub. No.: US 2009/0167489 A1
(43) Pub. Date: Jul. 2, 2009

(54) ANTI-FORGERY METHOD AND APPARATUS BASED ON CPK ELECTRONIC TAG

(76) Inventors: XiangHao Nan, Beijing (CN); Jianguo Zhao, Beijing (CN)

Correspondence Address: MCDERMOTT WILL & EMERY LLP, 600 13TH STREET, N.W., WASHINGTON, DC, 20005-3096, US

(21) Appl. No.: 12/293,476

(22) PCT Filed: Jan. 11, 2007
(86) PCT No.: PCT/CN2007/000116

§ 371 Date: Sep. 18, 2008

(30) Foreign Application Priority Data
Mar. 23, 2006 (CN) 200610065663.7

(51) Int. Cl. G06F 7/04

(52) U.S. Cl. 340/5.8

(57) ABSTRACT

An anti-forgery method and apparatus based on combined public key (CPK) electronic tag is provided. The CPK electronic tag is implemented by CPK crypto scheme and RFID, to perform self-signing on predefined ID, and to ensure uniqueness and authenticity of the item by binding the item and the tag, to prevent duplicating and counterfeiting.

### FIELD OF INVENTION

The present invention relates to authentication and anti-forgery technology. In particular, the present invention relates to an anti-forgery method and apparatus based on CPK (Combined Public Key) electronic tag.

### BACKGROUND OF INVENTION

Counterfeits and inferior goods not only seriously impact the country's economic development, but also jeopardize the vital interests of enterprises and consumers, which further disturb social economic order. In order to protect the interests of enterprises and consumers and to ensure healthy development of market economy, the state and enterprises have to spend massive manpower and financial resources each year against forgeries. Common anti-forgery products and technologies available in the domestic market include: hologram, anti-forgery ink, and hidden label on the product and package. However, such technologies do not have uniqueness and exclusiveness, easy for duplicating, and thus may not function well against counterfeits.

Currently, there is a trend in the international anti-forgery field to use electronic technology against counterfeits, especially the use of radio frequency tag, the advantages of which attract extensive attention. However, since the key distribution technique in logical anti-forgery function is not flexible, the focus of anti-forgery still lies on physical structure of RFID. The function of logical anti-forgery seems starchy, as only the issuer can provide signature. Thus, with different issuers, the authenticating devices may be different as well, which brings inconvenience to the manufacturing management of authenticating devices. That is, the anti-forgery authenticating devices can only be specialized, rather than generalized. Thus, its application is greatly limited.

Therefore, there is a need to acquire a high security generalized anti-forgery technology, so as to enable quick authentication.

### SUMMARY OF INVENTION

In view of the above, one object of the present invention is to provide an anti-forgery method based on CPK electronic tag. A novel anti-forgery and authentication technology combining physical and logical means is created through self signature by the item ID identity, so as to simplify anti-forgery management of the items.

To achieve the above object, an anti-forgery method based on CPK electronic tag is provided, wherein the CPK electronic tag combines physical RFID anti-forgery technology with logical CPK algorithm, with no signature needed from the issuer, rather self-signed by the item ID identity, to realize integration of the electronic tag and the item, so as to verify the item. The method comprises the following steps:

using a private-key matrix (rᵢⱼ) to perform self-signing on the pre-defined ID, to generate a CPK electronically signed tag;

binding the item and CPK electronic tag, to ensure integration and authenticity of the item; and

authenticating the CPK electronic tag with a public-key matrix (Rᵢⱼ) to determine authenticity of the item.

The step of generating the electronic tag further comprises:

Certificate Authority (CA) has private-key matrix (rᵢⱼ) and mapping algorithm, in which the private-key matrix (rᵢⱼ) is protected by SAM card;

the Certificate Authority (CA) uses the private-key matrix (rᵢⱼ) and mapping algorithm, to generate a private key of the item ID identity defined by the producer, and the producer signs to the item ID identity, so as to obtain ID identity SIG_{ID}.

the producer writes the signature SIG_{ID} into memory (E²PROM) encapsulated in the RFID tag, to complete an ID identity electronic tag;

Further, the step of binding the electronic tag comprises:

incorporating physical properties of the electronic tag and the item, to realize integration of the electronic tag and the item;

the producer being responsible for binding the electronic tag with anti-forgery object, to ensure the tag and the item being inseparable, and any separation may cause damage to the electronic tag;

the tag and item, upon binding, can enter into circulation;

Further, the step of authenticating the electronic tag comprises:

each authenticating machine having CPK public-key matrix (Rᵢⱼ) and mapping algorithm, which can calculate the public key corresponding to any identity, so as to verify electronic tag of any identity;

the authenticating machine reading out signature in the memory E²PROM of RFID, performing authentication by using public key of the ID identity, and displaying the authentication result on the screen;

wherein, the authenticating function can be embedded in a hand-held device such as a cell-phone, to obtain a hand-held device with authenticating function.

Another object of the present invention is to provide a CPK electronic tag apparatus, wherein using entity identity to generate a private-key, and to form a signature tag, so as to enable on-spot authentication to electronic tags in circulation, given that the CPK public key matrix is available. The apparatus comprises:

an issuing system of electronic tag, for defining an item ID identity by the producer, the Certificate Authority (CA) generating an ID identity signature based on the ID identity applied by the producer, and embedded in a chip to produce an electronic tag;

a binding system of electronic tag, for binding the electronic tag and the item by the producer, so that any attempt to separate the electronic tag from the item may cause damage to the electronic tag;

an authenticating system of electronic tag, for authenticating any ID identity signature.

Further, wherein the authentication is non-contact, that can receive the result on-spot.

Further, wherein the radio frequency identity card (RFID) technology deals with automatic collection of data and physical duplication of tag, and CPK technology deals with authenticity proof and logical impersonation of data in RFID;

combining RFID and CPK sets a unique and unalterable ID number and item identity no. for each RFID internally, so that its code can only be identified by the authenticating machine and cannot be duplicated or counterfeited;

Further, wherein one RFID has a unique ID no., and has ID identity defined by various producers;

Further, wherein the ID identity includes factors such as producer name, item name, serial no., and the time stamp.

As a physical technology, radio frequency identification technology has a better anti-forgery property compared with other technologies such as laser anti-forgery and digital anti-forgery. Each chip of RFID has a unique identity no., the safety design and manufacturing process makes RFID hard to imitate.

As a logical technology, combined public-key (CPK) key algorithm settles identity-based scale key management, adapted to large-scale identity authentication, to realize identity self-signing for each identity, so as to logically prevent possible impersonation.

Physical chip prevents possible duplication, and logical authentication prevents possible impersonation, and provides means for quick authentication. Since authentication can be made to all identities, the authentication means can be generalized and popularized to make it available for everyone (can be embedded in the cell-phone), so as to enable on-spot authentication by anybody. This widespread net of counter-forgery will effectively suppress counterfeits, so as to stabilize economic order.

Other advantages, objects and features of the present invention will be set forth in the below text, and to a certain extent, they will become readily apparent to those skilled in the art with the following detailed description, or upon practice of the present invention. The objects and other advantages of the present invention will be realized and obtained through the below description, claims and the structure shown in the drawings.

### BRIEF DESCRIPTION OF DRAWINGS

In order to better understand the objects, technical solutions and advantages of the present invention, detailed description will be set forth with reference to the accompanying drawings, wherein:

FIG. 1 shows a CPK electronic tag generation process according to one embodiment of the present invention;

FIG. 2 shows a CPK electronic tag authentication process according to one embodiment of the present invention;

FIG. 3 shows structure of a CPK electronic tag anti-forgery ticket management system of the present invention; and

FIG. 4 shows workflow of CPK electronic tag used in tobacco industry.

### DETAILED DESCRIPTION OF PREFERRED EMBODIMENTS

The preferred embodiments of the invention will be described hereinafter with reference to the drawings.

CPK refers to Combined Public Key. The CPK key management system is an identity-based key generation and management system based on mathematical problem of discrete logarithm. It forms public-key and private-key matrices based on mathematical problem of discrete logarithm, and uses hash function and cryptographic transformation to map the entity identity to row coordinates and column coordinates in the matrix, to select and combine the matrix elements, to generate huge amount of public/private key pairs formed by public keys and private keys, so as to perform identity-based key generation and distribution on an ultra-large scale.

CPK key algorithm uses discrete logarithm and elliptic curve cryptography to form public/private key pairs, and uses mapping algorithm to bind public/private key variables and user identity, so as to realize identity-based key management. CPK key management adopts centralized mode, with key generation and distribution centralized, which is controllable and manageable, to facilitate construction of top-to-bottom network trust system. In addition, CPK key management adopts the running mode of dispersed storage and static invocation of keys, so as to realize third-party and non-prior authentication.

According to the present invention, the CPK electronic tag system mainly includes two parts: 1) issuing system of electronic tag; 2) authenticating system of electronic tag.

The item ID identity is defined by the producer, and the Certificate Authority (CA) generates signature of the ID identity based on the ID identity applied by the producer, which embeds in the chip to produce electronic tag;

The producer binds the electronic tag and the item, so that any attempt to separate the tag from the item may cause damage to the electronic tag;

The authenticating machine can verify any ID identity signature. The verification is non-contact, and result can be received on-spot.

The RFID deals with automatic collection of data and physical duplication of tag, and CPK deals with authenticity proof and logical impersonation of data in RFID. Combining RFID and CPK sets a unique and unalterable ID number and item identity no. for each RFID internally, so that the code can only be identified by the authenticating machine and cannot be duplicated or counterfeited.

One RFID is provided with a unique ID number, while at the same time is provided with ID identities defined by various producers, in which the ID identity includes factors such as producer name, item name, serial No., and the time stamp, etc. In identity-based scale authentication system, it is easy to generalize and popularize the authenticating machine. Thus, the present invention can be widely applied in anti-forgery of various items (containers, licence plates, certificates, trademarks), banknotes, passenger tickets, and admission tickets, etc., and authentication can be conducted by using common authenticating machines.

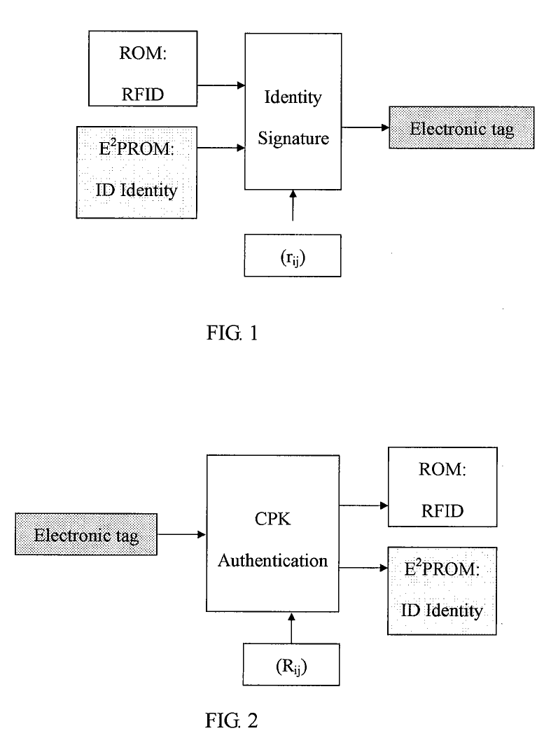

FIG. 1 illustrates generation process of CPK electronic tag according to one embodiment of the present invention. As illustrated in FIG. 1, the Certificate Authority (CA) has private key matrix (rᵢⱼ) and mapping algorithm, wherein the private key matrix (rᵢⱼ) is protected by SAM card. The Certificate Authority (CA) uses the private key matrix (rᵢⱼ) and mapping algorithm, to generate a private key for the item ID identity defined by the producer, to perform digital signature to the item ID identity: SIG_{ID} (ID identity), and to lock/write into memory (E²PROM) capsulated in RFID tag, in order to complete an ID identity electronic tag.

By incorporating physical properties of electronic tag and item, integration of electronic tag and item can be realized. The producer is responsible for binding the electronic tag and anti-forgery object, to ensure inseparability of the tag and item. Separation may cause damage to the electronic tag. The tag and item, upon binding, may enter into circulation.

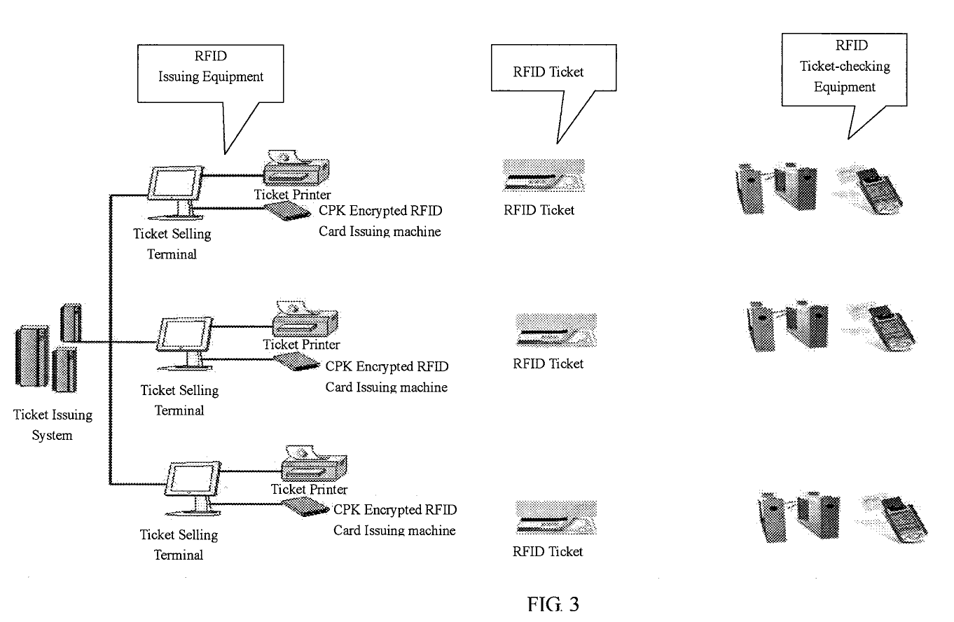

FIG. 2 illustrates authentication process of CPK electronic tag according to one embodiment of the present invention. As seen in FIG. 2, each authenticating machine has CPK public key matrix (Rᵢⱼ) and mapping algorithm, which can calculate public key corresponding to any identity, and thus can authenticate electronic tag of any identity. The authenticating machine reads out signature data in the memory E²PROM of RFID, and uses public key of the ID identity to verify, with the result displaying on the screen. Since the data volume of public key matrix (Rᵢⱼ) in the authenticating machine is relatively small, the authenticating function can be embedded in hand-held devices, such as cell phones, to allow it have authenticating function. This makes the authenticating function available for anyone to check.

Since the electronic tag and item are integrated, proof of item authenticity can be realized.

Detailed description will be made hereinafter with respect to some typical applications of CPK electronic tag in connection with the drawings. However, it is noted that the present invention may embody different forms and shall not be understood as limited to the embodiments described herein. Rather, the embodiments are provided for completeness and thoroughness of the disclosure, and can fully express scope of the present invention to those skilled in the art.

### EMBODIMENT 1

As seen in FIG. 3, it shows a structure of CPK electronic tag anti-forgery management system for ticket affairs. Here, the ticket affairs include admission tickets, passenger tickets, and banknotes etc. Comparing with traditional ticketing, the ones using RFID electronic tag improves processing efficiency. In addition, reliable anti-forgery and automatic authentication can be performed to the tickets. In a specific admission ticket system, it can identify the number of times the ticket has been used, to prevent the ticket being reused by secretly passing on, i.e., “frequency anti-forgery”.

As seen in FIG. 3, the ticket anti-forgery system includes: ticket issuing equipment 2, ticket checking equipment 4, and RFID electronic ticket 3. Based on the functions, it can be divided into three function modules: ticket issuing, ticket checking, and data collecting and analyzing.

(I) Ticket issuing system 1 includes ticket production part and distribution part, equipped with card issuing terminal, printer, SAM card of the function domain, and RFID card issuing machine. The user system (producer) provides item UID, CPK algorithm and private key matrix in the SAM card, and software at the issuing terminal, to embed the UID signature data in the ticket printer. When printing a ticket, the RFID card issuing machine has already written relevant anti-forgery information into RFID tag of the ticket.

The relevant anti-forgery information includes: encrypted UID, encrypted code of ticket purchaser, encrypted code of issuer, encrypted game information (e.g., time, place, game and number), and encrypted seat information, and the like. All the information is stored as cryptograph after signed by the RFID card issuing machine.

(II) For ticket checking process, the authenticating machine can easily perform offline authentication. The process of offline authentication is as follows:

Through CPK decryption, the authenticating machine reads out and displays relevant information stored in RFID, by determining whether the decrypted UID conforms with UID of the RFID itself, and whether the game information conforms with current ones, etc., to quickly determine authenticity of the ticket offline.

When audience with RFID tickets enters, he only needs to pass by the ticket checking equipment, which can instantly identify authenticity of the ticket, to realize quick automatic ticket checking. In case of an audience has to temporarily leave, he also needs to pass by the checking equipment, to effectively prevent the audience leaving with several tickets.

(II) For data collection and analysis, upon completion of checking, the RFID ticket checking equipment may upload the checking information (including information on the ticket being checked, checking time, etc.) to the server, and the data monitoring and analyzing software running on the server may collect and analyze the uploaded information. If network checking system is adopted, the organizer can also perform real-time monitoring on the checking process.

### EMBODIMENT 2

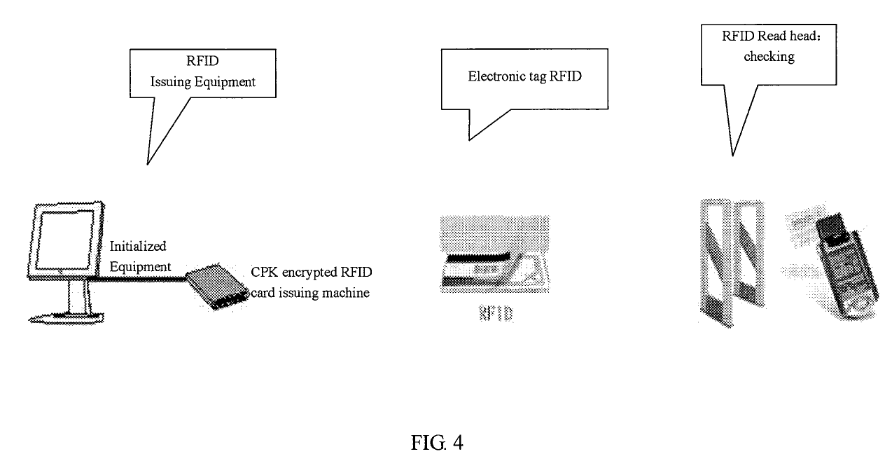

As seen in FIG. 4, it shows workflow of CPK electronic tag used in tobacco industry.

Construction of data center is the No. 1 project for tobacco industry informatization, and is the nerve center of digital tobacco. The project requires marking the cigarettes with barcode when being off production line, to designate a unique identity for each piece of cigarette. With this, each tobacco Certificate Authority (CA) conducts production with the barcodes issued by the State Administration, so that the tobacco production is under planned control. On the other hand, by determining identity (e.g., brand, grade, place) for each piece of cigarette through reader from off production line to leaving the factory to delivery, and returning such information to the state administration, information of each piece of cigarette can be traced.

Centralized management of cigarette information is an extraordinary bulky and complicated work. For information tracking of all cigarettes alone, it requires a plurality of repeated scanning process, from leaving the factory, arrival verification, logistic distribution, counting and checking, stock counting, to retail terminal. Implementation of RFID may give each carton of cigarettes a “life”; to make itself have memory function, that can automatically tell its own no., place, date of production, serial number, time of leaving factory, flow, and final arrival time, even more specifically to its transportation procedure, and exactly current location (even if currently it is out of your visual scope). To apply RFID technology to tobacco industry will certainly save a huge amount of capital and labor, and greatly improve the work efficiency and accuracy.

Application of CPK electronic tag in tobacco management and anti-forgery: RFID deals with automatic collection and physical anti-forgery of the tag, while CPK deals with authentication and signature of data in RFID. Combination of CPK with RFID effectively solves tobacco anti-forgery issue.

Application of CPK system based RFID in tobacco industry can perform the following functions:

1) Anytime one can automatically track the no., place, date of manufacture, serial number, date of leaving factory, flow, and final arrival time of various cigarettes, even more specifically to its transportation procedure.

2) Facilitate to improve the tracking and management ability of tobaccos, from production to circulation to distribution, which reduces cost of production and circulation.

3) Facilitate material tracking, container tracking during manufacturing process, consecutive first-in-first-out (FIFO) stock management, and quality control of final products.

4) Effectively inhibit inferior/counterfeited cigarettes in the market, purify fake products in the industry, and intangibly increase sales volume.

5) Truly reflect sales data and dynamically reflect change of stock volume, which helps the management level to improve decision-making ability.

6) Since RFID technology can ensure high-quality data exchange in the supply chain, it can play an important role in tobacco monopoly administration. It effectively inhibits or even stops circulation out of the system, by thorough implementation of “source” tracking solution and with the ability of fully embodying its transparence in the supply chain.

As seen in FIG. 4, the workflow of CPK electronic tag in tobacco industry is as follows:

1) Writing Ex-Factory Information

Each cigarette factory (producer) defines electronic tag for each product, or if desired, for each carton of cigarettes, or package, wherein identity follows standard definition, including function domain, i.e., type of producer, type of item, etc. The identity is recorded to the tag chip by the card issuing equipment 5. In addition, other information recorded in the tag includes product name, grade, production lot size, destination, and the like. All the information uses CPK algorithm UID signature, with the signature stored in RFID tag 6, which can only be read out and cannot be edited, so as to effectively realize anti-forgery.

2) Data Verification in Circulation

Each RFID tag 6 is unique, which represents the sole identity of each piece (carton, box) of cigarettes. The cigarettes, upon entering into circulation, at each stop, even when reaching the final users, the RFID system can always be checked by the authenticating machine, to enable on-spot authentication of the item. The authenticating machine 7 can be specialized or generalized. In this way, a customer can check its authenticity when purchasing a carton of cigarettes.

### EMBODIMENT 3

Application of CPK electronic tag in vehicle management and anti-forgery

Relevant information including all the information related to the vehicle when purchasing or at annual inspection, such as date of purchase, attributed place, plate No., engine No., frame No., and information concerning annual inspection and payment, will be written into RFID upon encryption, which then attaches to the windshield.

When checking the vehicles, the traffic police can read relevant information in RFID at any time by using the authenticating machine, to conduct on-spot authentication to the relevant information. Vehicles being stolen, breaching traffic rules, with overdue fees and being refitted can be promptly detected. The authenticating machine can be specialized or generalized.

### EMBODIMENT 4

CPK electronic tag used for anti-forgery of computer products, adopts same principles as those for management of tobacco and vehicles, in which the identity such as model and serial number of important parts of products and relevant information use UID signature, which are stored into RFID.

Thus, specialized or generalized authenticating machine can conduct authentication, to detect any loss or replacement of parts.

Embedding CPK electronic tag in CDs (new type of CDs) can effectively provide genuine copy identity. The customer can identify genuine copy or pirated copy on-spot when purchasing.

If authenticating machine is embedded in the computer(new component of computer), it can support anti-forgery operation of CD. With respect to duplicating software after being read out, it can be controlled by special installation program developed by the producer.

### EMBODIMENT 5

Application of CPK electronic tag in logistic system

(I) Application of CPK Electronic Tag in Tobacco Logistic Management

The CPK electronic tag provides data entry function in the course of circulation. In order to monitor the cigarettes throughout the circulation, writing of RFID is provided in the circulation link. Writing of RFID in the circulation link may only provide to the memory area other than the one storing ex-factory information, with no connection to identity authentication. However, it can easily provide any RFID tag which clearly and accurately describes “identity” of the piece (carton) of cigarettes, its storage and transportation record, destination, and other useful information. Once the product has any problem, RFID certainly is a solution to track source of the cigarettes, and thus can respond to any issues such as “where are the cigarettes coming from, and whether the intermediate processing link is perfect”, and give detailed and reliable response.

Currently the tobacco industry follows the concentrative trend, which indicates that “one-stock” distribution and operation mode of “modern logistics” will be more and more applied to large-scale busy logistic distribution. High-tension work environment and strict cost control demand make powerful management function of RFID solution with harsher requirement to logistic management satisfy such requirement in tobacco industry.

When cigarettes with RFID tag arrives logistic distribution center, RFID system can perform automatic entry function: when the stock enters into the warehouse, reader on the gate can immediately read the tag information of all cigarettes in the stock, even for those stacked at the bottom. The system will check the information with the shipping records stored in the tag, to detect possible mistakes, and then write the updated cigarette storage place and status to RFID tag upon encryption. In this way, it ensures precise inventory control, even the information such as number of boxes of cigarettes on transportation, departure place and destination, and anticipated arrival time.

The logistic distribution center needs to distribute goods based on each order. Currently this work requires a large amount of manpower, having efficiency and precision issues. Once there is a mistake, it takes huge amount of time and energy to re-locate and correct, and thus a number of re-checks are necessary. With CPK-based RFID system, one only needs to quickly fill in the stock based on the order; and, prior to distribute, the system will automatically check all out-storage cigarettes with the reader, to ensure supplying proper goods and correct quantity. On more advanced automatic sorting line, entire automatic sorting can be achieved based on RFID tag per the order, so as to realize automatic self-service logistic sorting and warehouse management.

When the cigarettes arrive at the retailers, RFID system can monitor every shelf (i.e., intelligent shelf). At the time of verifying authenticity, it can find out sales amount of each kind of cigarettes, to timely provide the retailers with indication of stock-out and reorder. At the same time, RFID technology can also be used to against burglar, quick intelligent check-out, and even analyze purchasing habits and tendency of customers.

(II) Application of CPK Electronic Tag in Military Logistic Management

The control and management of military logistics relates to military life, training, on duty, and military operations, which has become an important part of battle power. Nowadays with the high-level informatization of military logistics, technologies such as barcode, radio frequency, database, global positioning, geographical information, and satellite telecommunication have been used, to establish modern military combat system.

CPK electronic tag used in military logistics provides a novel anti-forgery and identification means for modem logistic management, for managing and identifying containers, whole machines, components, and individual soldiers. From this, it can be seen that military logistics includes a wide range of contents. Thus, various electronic tags are designed according to different objects and purposes.

CPK electronic tag connects with satellite positioning system, for positioning various objects and identifying friend-or-foe, including airplanes, vehicles and vessels, important weapons and individual soldiers, the telecommunication distance of which is settled by the telecommunication technology.

CPK electronic tag connects with database system, for item management and authentication, which can be directly used for military command.

CPK electronic tag will be more widely applied in modern weapon management and modern battling in the army.

Although the present invention has been illustrated and described with reference to some preferred embodiments hereof, it should be understood that people skilled in the art can make various modifications in form and details, without departing from the spirit and scope of the appended claims.

We claim:

1. An anti-forgery method based on CPK electronic tag, wherein the CPK electronic tag combines physical RFID anti-forgery technology with logical CPK algorithm, and the electronic tag does not need signature from an issuer, rather self-signed directly by an item ID identity, by performing integration of the electronic tag and the item, to verify authenticity of the item, the method comprises the steps of:
using a private key matrix (rᵢⱼ) to perform self-signing of pre-defined ID, to generate the CPK electronic tag;
binding the item and the CPK electronic tag, to ensure uniqueness and authenticity of the item; and
using a public key matrix (Rᵢⱼ) to verify the CPK electronic tag, to determine authenticity of the item.

2. The anti-forgery method according to claim 1, wherein the step of generating the electronic tag comprises:
Certificate Authority (CA) has the private key matrix (rᵢⱼ) and mapping algorithm, wherein the private key matrix (rᵢⱼ) is protected by a SAM card;
the Certificate Authority (CA) uses the private key matrix (rᵢⱼ) and the mapping algorithm, to generate a private key for the item ID identity defined by a producer, to perform digital signing to the ID identity, so as to obtain ID identity SIG_{ID}; and
the Certificate Authority (CA) locking/writing the sign SIG_{ID} into a memory E²PROM of RFID tag, to obtain the electronic tag of the ID identity.

3. The anti-forgery method according to claim 1, wherein the step of binding the electronic tag comprises:
incorporating physical property of the electronic tag and the item, to integrate the electronic tag and the item;
the producer being responsible for binding the electronic tag and anti-forgery object, to ensure the tag and item being inseparable, wherein separation causes damage to the electronic tag; and
the tag and item upon binding, entering in circulation.

4. The anti-forgery method according to claim 1, wherein the step of verifying the electronic tag comprises:
each authenticating machine having CPK public key matrix (Rᵢⱼ) and mapping algorithm, which calculates public key corresponding to any identity, so as to verify electronic tag of any identity; and
the authenticating machine reading out signature data in the memory E²PROM of RFID, performing authentication with public key of the ID identity, and displaying a result on a screen.

5. The anti-forgery method according to claim 1, wherein the authentication function is embedded in a hand-held device, such as a cell phone, to obtain a hand-held device with authentication function.

6. A CPK electronic tag apparatus, using entity identity to generate a private key, and form a digital signature, so that electronic tag in circulation is verified on-spot when CPK public key matrix is available, the apparatus comprises:
an issuing system of the electronic tag, for defining an item ID identity by a producer, wherein Certificate Authority (CA) generates an ID identity signature based on the ID identity applied by the producer, which capsulated in a chip to make the electronic tag;
a binding system of the electronic tag, for binding the electronic tag and the item by the producer, so that any attempt to separate the tag from the item causes damage to the tag; and
an authenticating system of the electronic tag, for performing authentication for any ID identity signature.

7. The CPK electronic tag apparatus according to claim 6, wherein the authentication is non-contact, and authentication result is obtained on-spot.

8. The CPK electronic tag apparatus according to claim 6, wherein the radio frequency identification (RFID) technology deals with automatic collection of data and physical duplication of the tag, and the CPK technology deals with proof of authenticity and logical impersonation of data in the RFID; and
combination of RFID and CPK sets a unique and unalterable ID No. and item identity No. for each RFID internally, so that its code can only be identified by an authenticating machine, and cannot be duplicated or counterfeited.

9. The CPK electronic tag apparatus according to claim 6, wherein one RFID is provided with a unique ID No. and ID identity defined by various producers.

10. The CPK electronic tag apparatus according to claim 9, wherein the ID identity includes producer name, item name, serial number and time stamp.
